(19) United States
(12) Patent Application Publication
(10) Pub. No.: US 2021/0370754 A1
(43) Pub. Date: Dec. 2, 2021

(54) Electric Motor Vehicle Battery System

(71) Applicant: ElectraMeccanica Vehicles Corp., Vancouver (CA)

(72) Inventors: Aayush Tandon, Vancouver (CA); William Wright, Vancouver (CA); Roei Ornai, Vancouver (CA); Ahmed Ayoub, Vancouver (CA)

(21) Appl. No.: 16/762,091

(22) PCT Filed: Aug. 17, 2018
(86) PCT No.: PCT/CA2018/051001

§ 371 Date: May 6, 2020

Related U.S. Application Data
(60) Provisional application No. 62/609,189, filed on Dec. 21, 2017.

(51) Int. Cl. B60K 1/04; B60L 50/60; H01R 11/28

(52) U.S. Cl. CPC B60K 1/04; B60K 2001/0438; H01R 11/281; B60L 50/66

(57) ABSTRACT

A battery system for an electric motor vehicle comprises first and second battery cartridges that are installed in corresponding first and second battery compartments of the electric motor vehicle. The first battery cartridge has a power connector port with at least one of a shape, size, configuration and orientation that is different than the corresponding power connector port of the second battery cartridge. The first and second battery compartments are physically spaced apart and electrically coupled together by a bridging power cable. The bridging power cable comprises first and second connector ends that extend respectively into the first and second battery compartments, and the first connector end mates more easily with the first power connector port than with the second power connector port, and the second connector end mates more easily with the second power connector port than with the first power connector port.

### FIELD

This disclosure relates generally to an electric motor vehicle battery system.

### BACKGROUND

Packaging batteries in electric motor vehicles is an engineering challenge and requires a number of factors to be taken into consideration, including providing adequate cabin space, balancing weight, meeting safety and crash requirements, and providing servicing accessibility. In some electric motor vehicles, battery packs are placed under the rear seat or in the trunk. Other electric motor vehicles utilize a “skateboard” battery design, wherein the battery pack is part of the chassis and forms part of the floor of the vehicle.

In a single-occupant three-wheel electric motor vehicle such as that disclosed in International PCT application PCT/CA2017/050607, a battery system comprises a pair of battery cartridges installed in lateral battery compartments located on the outboard sides of a cockpit. Such a vehicle design presents unique challenges to the battery cartridge design. For example, when the battery cartridges comprise multiple battery modules and a battery management system is provided to monitor and control the operation of each battery module, it is important for each battery module to be correctly connected to the battery management system in order for the battery management system to perform battery management actions on the correct battery modules.

It is an objective of the invention to provide a battery system that addresses at least some of the challenges in the prior art.

### SUMMARY

According to one aspect of the present invention, there is provided a battery system for an electric motor vehicle comprising at least two battery cartridges and at least two battery compartments for receiving the at least two battery cartridges. The battery cartridges comprise first and second battery cartridges, wherein the first battery cartridge has a first power connector port with at least one of a shape, size, configuration and orientation that is different than a second power connector port of the second battery cartridge; and the at least two battery compartments comprise first and second battery compartments physically spaced apart and electrically coupled together by a bridging power cable. The bridging power cable comprises first and second connector ends that extend respectively into the first and second battery compartments; the first connector end mates with the first power connector port and the second connector end mates with the second power connector port.

The first connector end can match the shape, size, configuration and orientation of the first connector port but not match at least one of the shape, size, configuration and orientation of the second connector port. Similarly, the second connector end can match the shape, size, configuration and orientation of the second connector port but not match at least one of the shape, size, configuration and orientation of the first connector port. For example, the first power connector port can have a different orientation on the first battery cartridge than the second power connector port on the second battery cartridge, and the bridging power cable can be affixed to the vehicle such that the first and second connector ends have orientations that respectively match the orientations of the first and second power connectors when the first and second battery cartridges are respectively mounted in the first and second battery compartments.

More particularly, the first and second power connector ports can each have a keyhole shape with a notch section, wherein the notch section of the first connector port has a different orientation than the notch section of the second connector port. The notch sections can face inwardly when the first and second battery cartridges are mounted respectively in the first and second battery compartments.

The first and second battery compartments can be part of a rolling chassis of the electric motor vehicle and can be located adjacent to a cockpit of the electric motor vehicle. The first and second battery compartments can each further comprise an access port communicative with the cockpit and providing access for a person's hand to reach one of the respective first and second connector ends and one of the respective first and second connector ports when the first and second battery cartridges are mounted inside the first and second battery compartments.

At least one of the first and second battery cartridges can further comprise a locator pin extending from a front end of the battery cartridge. A front end of the corresponding battery compartment can comprise a locator hole for receiving the locator pin and for positioning the battery cartridge such that the power connector port is connectable to the connector end in the battery compartment. At least one of the first and second battery cartridges can further comprise a mounting bracket extending from a rear end of the battery cartridge, and which aligns with at least one securing bolt when the battery cartridge is positioned with the locator pin in the locator hole, such that the battery cartridge can be secured to the battery compartment only by the at least one securing bolt.

The first and second battery cartridges can each further comprise a plurality of battery modules electrically connected sequentially in series. A last battery module in the first battery cartridge can be electrically coupled to a front power connector port of the first battery cartridge, and a first battery module in the second battery cartridge is electrically can be coupled to a front power connector port of the second battery cartridge.

The first and second battery cartridges can each further comprise a communications bus comprising an external communications port for communicatively coupling to a battery management system, and multiple pin connectors communicatively coupled to sensors inside the battery compartment. For example, the communication bus in each of the first and second battery cartridges can be communicatively coupled to at least one voltmeter or at least one thermistor inside the first and second battery cartridges.

### DRAWINCIS

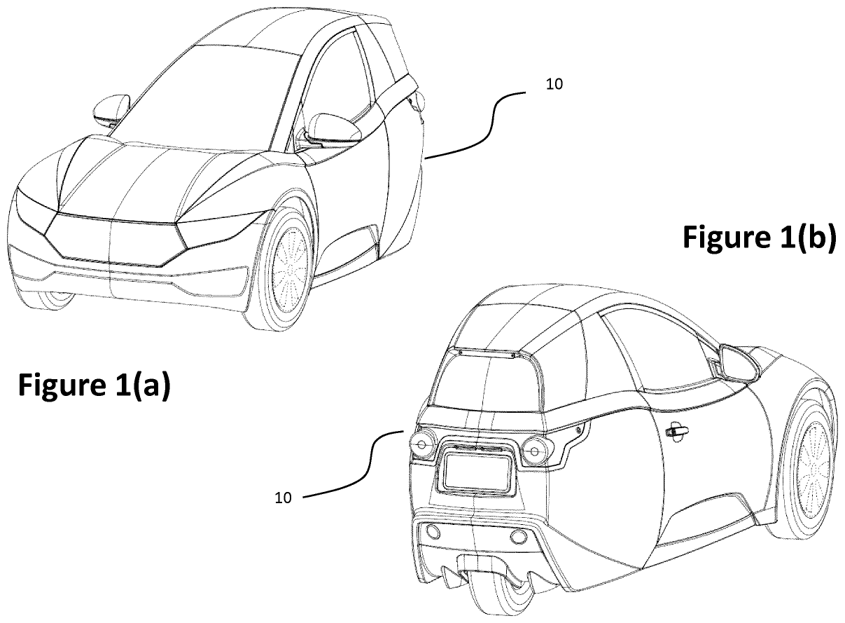

FIGS. 1(a) and (b) are top front right and top rear right perspective views of an electric motor vehicle comprising a battery system having a pair of battery cartridges according to an embodiment of the invention.

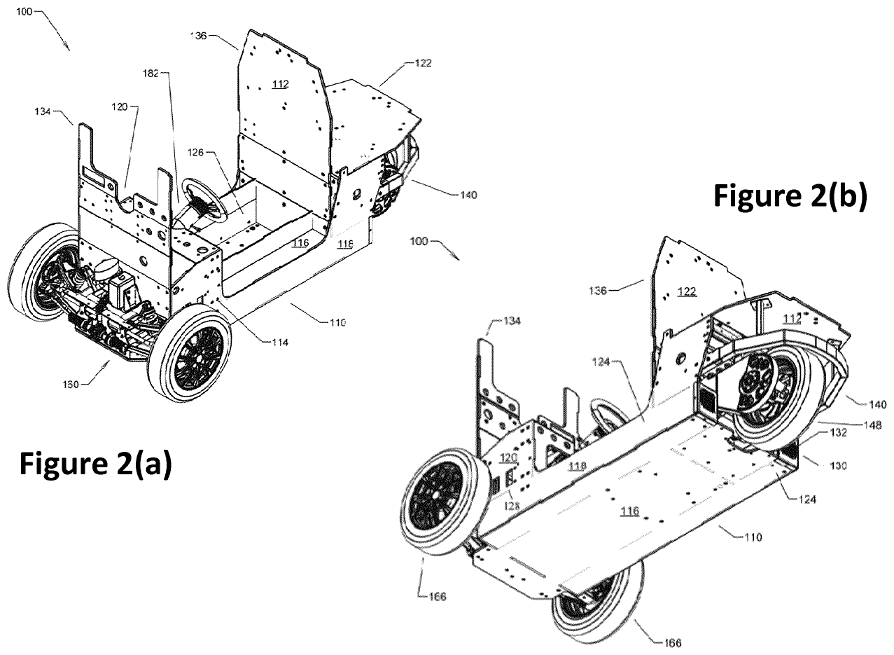

FIGS. 2(a) and (b) are top front right and bottom rear right perspective views of an embodiment of a rolling chassis of the electric motor vehicle shown in FIGS. 1(a) and (b).

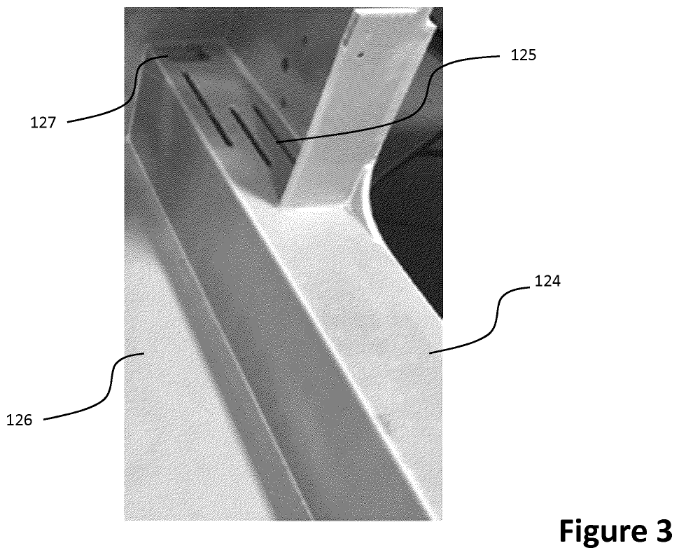

FIG. 3 is a detailed perspective view a cockpit portion and right battery compartment of the rolling chassis.

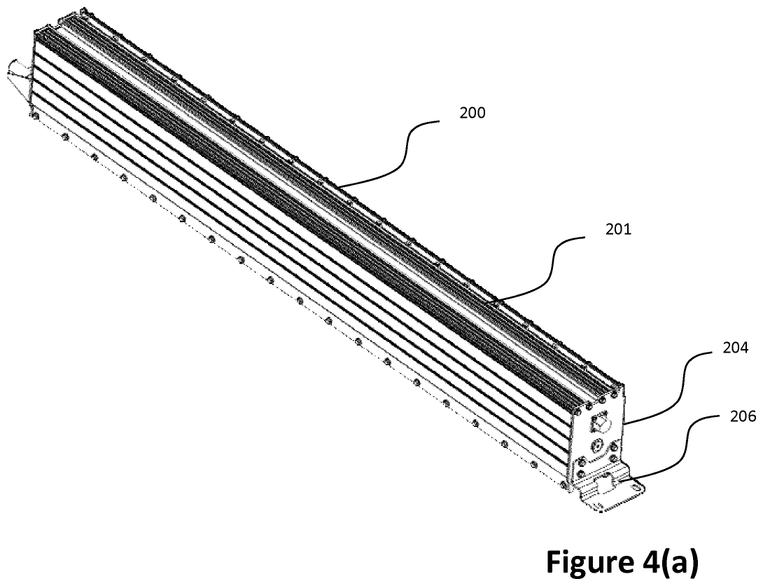

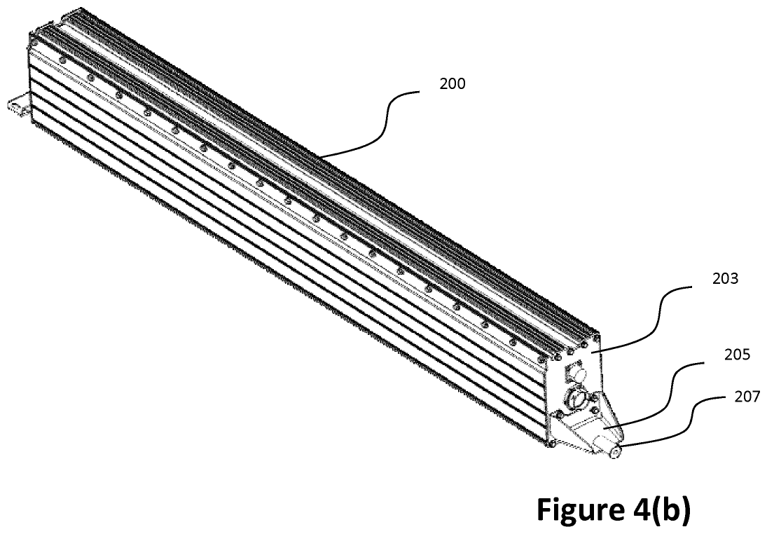

FIGS. 4(a) and (b) are top front and top rear perspective views of one of the battery cartridges.

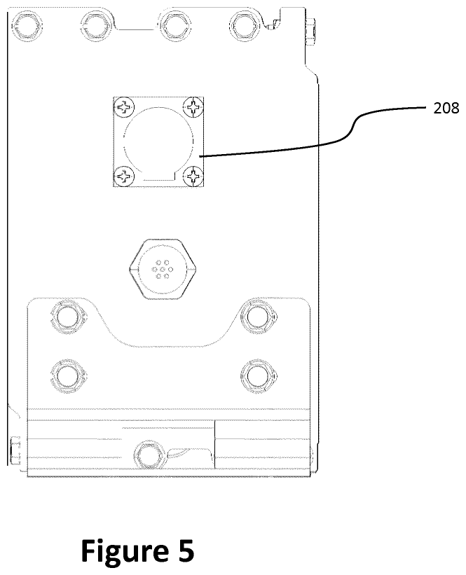

FIG. 5 is a rear end view of a left battery cartridge.

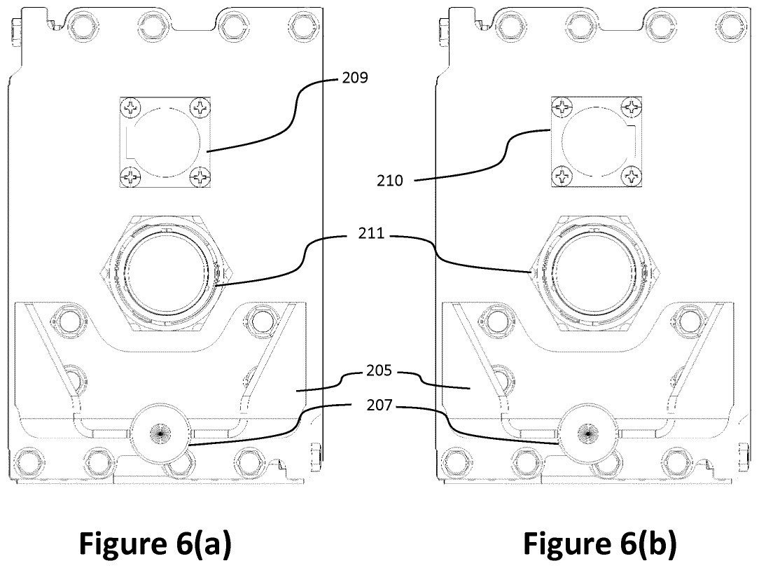

FIGS. 6(a) and (b) are front end views of the left and right battery cartridges.

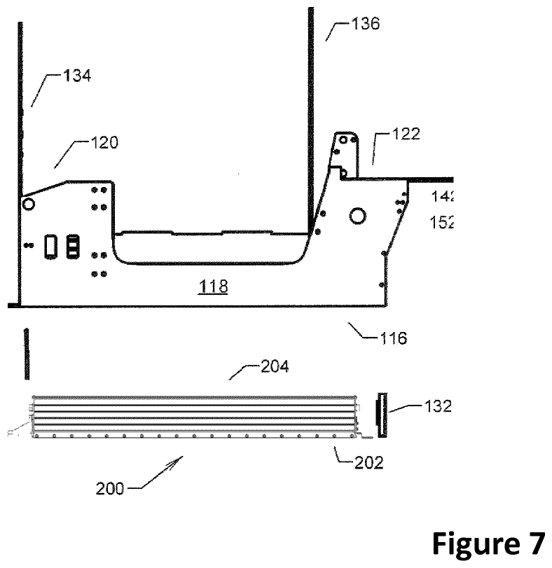

FIG. 7 is right side view of the rolling chassis and a battery cartridge.

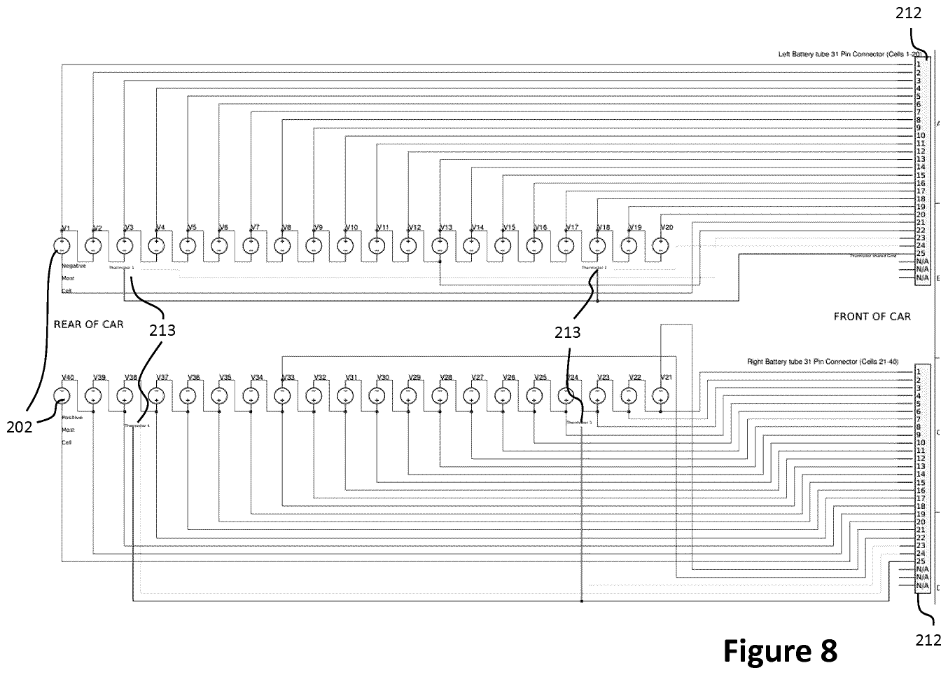

FIG. 8 is a communications wiring schematic of battery modules connected to a communications bus in each of the left and right battery cartridges.

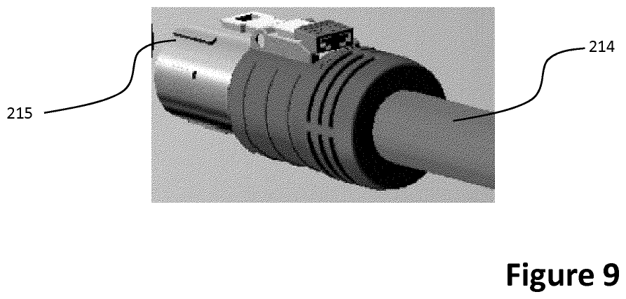

FIG. 9 is a perspective view of a portion of a bridging power cable for electrically coupling the left and right battery cartridges.

The structure of the invention will now be illustrated by explanation of specific, non-limiting, exemplary embodiments shown in the drawing figures and described in greater detail herein.

### DETAILED DESCRIPTION

Embodiments of the invention described herein relate generally to a battery system for an electric motor vehicle comprising multiple battery cartridges that are mounted in battery compartments that are physically separated but electrically coupled together in series by a bridging power cable. In certain embodiments, the battery system comprises first and second battery cartridges and first and second battery compartments, with each battery cartridge containing a group of battery modules electrically connected together in series. The first battery cartridge is electrically connected to the second battery cartridge by the bridging power cable, such that the last battery module in the first battery cartridge is electrically connected to the first battery module in the second battery cartridge in series. Each battery module is also communicative with a battery management system, which monitors the voltage of each battery module and the temperature of the battery cartridges, and performs cell balancing and other battery management functions. To ensure that the first and second battery cartridges are correctly located in the corresponding first and second battery compartments, the first battery cartridge is provided with a first power connector port that has at least one of a shape, size, configuration and orientation that is different than a second power connector port on the second battery cartridge. Accordingly, the bridging power cable is provided with first and second connector ends that extend respectively into the first and second battery compartments, and connect respectively with the first and second power connector ports.

In some embodiments, the difference in one or more of the shape, size, configuration and orientation between the first and second power connector ports enables a technician to readily confirm that the first and second battery cartridges are installed in the correct battery compartments, e.g. by visual or tactile confirmation. Additionally or alternatively, the first connector end of the bridging power cable matches the shape, size, configuration and orientation of the first connector port, but does not match at least one of the shape, size, configuration and orientation of the second connector port. Similarly, the second connector end matches the shape, size, configuration and orientation of the second connector port, but does not match at least one of the shape, size, configuration and orientation of the first connector port. Consequently, the first connector port more easily connects to the first connector end than the second connector end, and the second connector port more easily connects to the second connector port than the first connector port, which enables the technician to readily determine whether the first and second battery cartridges are installed in the correct battery compartments.

In this description, directional terms such as “upward”, “rearward”, “horizontal” and “vertical” are used to provide relative reference only and to assist the reader in understanding the embodiments described herein, and are not intended to restrict the orientation of any structure or its use relative to the environment.

Referring now to FIGS. 1 to 8 and according to one embodiment, a single-occupant three-wheeled electric motor vehicle 10 vehicle comprises a modular rolling chassis for a vehicle, generally illustrated at 100. The chassis is formed on a platform frame 110, and further includes a rear subframe 140, a front subframe 160 and a controls module (not shown). Certain portions of the chassis can be manufactured from composite panels, for example as a fiberglass skin over an aluminum honeycomb core. The composite panels can be cut or otherwise formed to the desired size and shape, connected together by fasteners 114, for example, as illustrated, fasteners commonly used in aerospace manufacturing, or adhesives or welds for example. The panel core can alternatively be formed from Nomex™ (a meta-aramid polymer), foam, titanium, plastic or wood, for example. Panel skins can alternatively be formed from carbon fibre, Kevlar™, (a para-aramid synthetic fibre), aluminum, titanium, steel, stainless steel, or wood, for example. In addition, biocomposites (for example with flax or hemp fibres), recycled carbon fibre, and recycled glass fibre might be incorporated into such panels used for these applications.

The platform frame 110 is formed as a platform 116 supporting a plurality of longitudinal joists 118 fastened thereto, and to both of which are fastened a front bulkhead 120 and a rear bulkhead 122. The platform frame 110 further includes left and right lateral battery compartments 124 extending from the front bulkhead to the rear bulkhead, and adapted to respectively receive left and right battery cartridges 200 for electrical grounding to at least one of the rear subframe 140 and the front subframe 160. The platform frame 110 further includes a cockpit portion 126 between the pair of lateral battery compartments 124; the cockpit portion 126 may form a structural support member of the platform frame 110, providing additional torsional and bending stiffness to the chassis 100. The front bulkhead 120 may support a windscreen frame 134 and the rear bulkhead 122 may support a roof panel 136 that is foldable to connect to the windscreen frame 134 to enclose the cockpit portion 126.

The rear subframe 140 is mountable to the rear bulkhead 122 and can support components such as a motor controller (not shown) electrically connectable to receive power from the battery cartridges 200, a motor (not shown), electrically connected to the motor controller, a swing arm (not shown) which may be a swing arm as disclosed in co-pending International application PCT/CA2017/050321 filed 10 Mar. 2017, which is incorporated herein by reference, a drive wheel 148 depending from the swing arm, and a drivetrain coupling the motor to the drive wheel 148. The motor controller may be electrically connectable to the controls module such that a user may use the controls module to direct the motor controller. The motor controller is mounted to the sub-frame 140 just above the motor. It regulates the torque/power going the motor to control speed and acceleration of the vehicle. The rear subframe 140 can form a structural support member, providing additional torsional and bending stiffness to the chassis 100.

The front bulkhead 120, the rear bulkhead 122 and the pair of lateral battery compartments 124 extending therebetween may individually or in combination form a structural support member of the platform frame, providing additional torsional and bending stiffness to the chassis 100. The pair of lateral battery compartments 124 has at least one cooling intake 125 and at least one cooling exhaust 130, the cooling intake being connected to receive air from the cockpit portion 126, for example climate controlled air. The cooling intake 125 may be located proximate the front bulkhead 120 and the cooling exhaust 130 located proximate the rear bulkhead 122, such that air received at the cooling intake may flow rearward through the pair of lateral battery compartments 124 and be exhausted proximate the rear bulkhead 122; in this regard, the cooling exhaust 130 may include an exhaust fan 132. But for the cooling intake, the pair of lateral battery compartments 124 may be thermally sealed from the cockpit portion 126, such that each battery cartridge 200 does not itself need to be sealed from the ambient environment.

As can be seen in FIG. 3, an access port 127 in the cockpit 126 is provided proximate to the front bulkhead 120 for each of the left and right battery compartments 124. Each access port 127 is positioned at the top of each battery compartment 124 towards the inward side thereof and is sized to allow a technician's hand to readily reach inside the battery compartment 124 and physically connect power and communications connector ends of the bridging power cable to respective power communication ports of the battery cartridges 200, as will be described in more detail below.

Referring now to FIGS. 4(a) and (b), each battery cartridge 200 comprises an elongated generally rectangular metal housing with heat exchange fins 201 extending along the length of the top and bottom of the housing. The housing contains multiple battery modules 202 (shown in FIG. 8) connected electrically together in series in an electrical circuit to provide power for the vehicle 10. In the embodiment shown in the Figures, each battery cartridge 200 houses 20 battery modules. Each module 202 contains multiple cells that are connected in parallel to increase capacity. The cells in the parallel configuration can be cylindrical, or pouch cells. The cylindrical cells can be Lithium Ion cells with a Nickel Manganese Cobalt (NMC) chemistry. NMC cells have excellent specific energy, and a low self-heating rate, which makes them an ideal choice for electric powertrains. However, different numbers and types of battery modules can be used in different embodiments.

The battery cartridge 200 further comprises a front end plate 203 and a rear end plate 204. A front mounting bracket 205 extends forwardly from the bottom of the front end plate 202, and a rear mounting bracket 206 extends rearwardly from the bottom of the rear end plate 204. The front end plate has a locator pin 207 that is configured to engage with a mating locator hole (not shown) in the front end of each battery compartment 124; the locator pin 207 can be threaded to allow a bolt (not shown) to be attached to the pin, thereby securing the front end of the battery cartridge 200 in place inside the battery compartment 124. The rear mounting bracket 206 is provided with a pair of bolt openings for receiving mounting bolts (not shown) that secure the rear end of the battery cartridge 200 in place inside the battery compartment 124. This configuration allows the battery cartridge 200 to be secured tightly in the battery compartment 124, yet allow relatively easy and quick installation and removal of the battery cartridge 200 from the battery compartment 124 for servicing, replacement etc.

Referring now to FIGS. 5 and 6(a) and (b), the rear end plate 204 of each of the left and right battery cartridges 200 is provided with a rear power port 208. Similarly, the front end plate 203 of each of the left and right battery cartridges 200 are provided with a front power port 209, 210. A bridging power cable 214 (shown in FIG. 9) has left and right connector ends 215 that extend into the front end of the left and right battery cartridges 200 respectively and are configured to mate with the left and right power connector ports 209, 210 respectively. Each front end plate 203 also comprises a communications port 211, which is communicative with a communication bus 212 (shown in FIG. 8) inside the battery cartridge 200, and is connectable to a communications cable (not shown) of a battery management system (not shown) of the vehicle 10.

The bridging power cable 214 extends across the cockpit and can be provided with a quick disconnect mechanism (not shown) that allows the power cable to be disconnected quickly, for example, in the case of an emergency. Suitable quick disconnect mechanisms are known in the art, and for example, include Powerpole® connectors.

Each power port 208, 209, 210, has a generally keyhole shape comprising a circle with an extending notch, and which corresponds to the shape and size of a connector end of the bridging power cable. To ensure that the left and right battery cartridges 200 are correctly inserted into the left and right battery compartments 124 respectively, the notch of each of the left and right power ports 209, 210 are configured to face the inward direction when their respective battery cartridges 200 are mounted inside the correct battery compartments, i.e. the front power connector ports 209, 210 have different orientations. When the battery cartridges 200 are inserted completely into their respective battery compartments 124, the front power ports 209, 210 will be within reach of a technician's hand when inserted through the respective left and right access ports 127. The technician will be able feel the notch of each power connector 209, 210 and quickly determine if the notch is facing inwards thereby confirming that the battery cartridge 200 is installed in the correct battery compartment.

As another means for determining that the battery cartridge 209, 210 is installed in the correct battery compartment 124, the bridging power cable 214 is affixed to the vehicle 10 in a manner that makes it more difficult for a technician to mate the power connector end of the cable to the power connector port 209, 210 when the notch is facing outwards instead of inwards. For example, the bridging power cable 214 can be affixed to the vehicle 10 such that that notch of the power connector end 215 faces inwards when inside the battery compartment 200. While the cable 214 will have some flexibility, it is relative hard to twist 180°. Therefore, it will be comparatively easier for a technician to mate the power connector end 215 to the power connector port 209, 210 when both notches are facing inwards, than to twist the cable 180° in order to make the power connector end 215 mate with a power connector port 209, 210 with its notch facing outwards.

As yet another means for determining that the battery cartridge 209, 210 is installed in the correct battery compartment 124 and as shown in FIG. 3, each front power connector port 209, 210 is located at the centerline of each battery cartridge 200, and each access port 127 is laterally offset from the centerline of each battery compartment 124. This arrangement forces a technician to insert his or her hand downwards through the access port 127 and laterally across inside the battery compartment 124 to reach the power connector port 209, 210.

Consequently, it will be a shorter reach for the technician to mate the power cable's connector end 215 with the power connector port 209, 210 when the power connector port's notch is facing inwards and is closer to the access port 127, than to mate the connector end 215 to the connector port 209, 210 when the power connector port notch is facing outwards and is further away from the access port 127.

The above configuration also allows the technician to connect the right and left connector ends 215 of the bridging power cable 214 to the respective right and left connector ports 209, 210 of the left and right battery cartridges 200 without sight. That is, the technician can use each access ports 127 to reach inside the corresponding battery compartment 124 to connect the connector end 215 to the corresponding power port 209, 210 entirely by feel. This provides a quick, efficient and accurate way to connect the battery cartridges 200 to the vehicle's power systems.

Referring to FIG. 8, each battery module 202 within each battery cartridge 200 is connected in series, with the battery modules 202 in the left battery cartridge 200 labelled sequentially from V1 to V20, and with the battery modules in the right battery cartridge labelled sequentially from V21 to V40. Furthermore, the positive terminal of the last battery module V20 in the left battery cartridge is electrically coupled to the front power port 209 of the left battery cartridge 200, and the first battery module V21 in the right battery cartridge 200 is electrically coupled to the front power port 210 of the right battery cartridge 200. Therefore, all the battery modules V1-V40 are connected together electrically in series when the bridging power cable is connected to the front left and right power ports 209, 210. The first battery module V1 in the left battery cartridge 200 is electrically coupled to the rear battery port 208 in the left cartridge 200, and the last battery module V40 in the right battery cartridge 200 is electrically coupled to the rear battery port 208 in the right battery cartridge. The rear power ports 208 of the left and right battery cartridges 200 can be electrically coupled to a motor controller (not shown) and a contactor box (not shown) to complete the electrical circuit.

The left and right battery cartridges 200 each also comprise a communications bus 212, that in turn is communicative with each battery module 202 in the battery cartridge 200. Each communication bus 212 comprises multiple connector pins that are communicative with the communication port 211 of the battery cartridge 200 and with sensors inside the battery cartridge 200. In the exemplary communications buses 212 shown in FIG. 8, each communications bus has 31 connector pins, with 20 of the connector pins connected by wiring to voltmeters (not shown) associated with each battery module 202. Each voltmeter provides a voltage measurement of its associated battery module, and these voltage measurement can be used by the battery management system to monitor performance of the battery modules 202 and perform cell balancing in the manner known in the art. Additionally, four thermistors 213 in each battery cartridge 200 are wired to the communications bus 212 to provide temperature measurements of different regions inside the battery compartment.

The battery management system comprises left and right communication cables (not shown) which extend into the left and right battery compartments 124. Each communication cable has a connector end with pins that connect to the pins of a respective communications bus 212. Because each battery module 202 uniquely communicates with the battery management system via the communications bus 212, it is important that the left and right communications buses 212 are correctly connected to the battery management system. Failure to do so may result in damage to the battery management, and for example, may pose a personal safety risk or fire risk from energy from the battery modules 202. Further, leaving the battery management system connected to modules 202 that are incorrectly wired may drain incorrectly wired modules 202, and may even permanently damage incorrected connected modules 202.

In alternative embodiment, the communications port 211 of each of the left and right battery compartments 200 are provided with a unique configuration that readily mates with a corresponding left and right communications connector end, and does not readily mate with the non-corresponding left and right connector end. For example, the left and right communications port 211 can have a similar circular shape with outboard directional notch like the power ports 209, 210, or some other shape or configuration.

In another alternative embodiment, the power ports 209, 210 can be provided with a different configuration, size or shape than the circular shape with directional notch. For example, one power port can have a curved shaped, and the other power port can have angled shape. In another example, the left and right power ports 209, 210 can have different sizes.

The terminology used herein is for the purpose of describing particular embodiments only and is not intended to be limiting. Accordingly, as used herein, the singular forms “a”, “an” and “the” are intended to include the plural forms as well, unless the context clearly indicates otherwise. It will be further understood that the terms “comprises” and “comprising,” when used in this specification, specify the presence of one or more stated features, integers, steps, operations, elements, and components, but do not preclude the presence or addition of one or more other features, integers, steps, operations, elements, components, and groups. Directional terms such as “top”, “bottom”, “upwards”, “downwards”, “vertically”, and “laterally” are used in the following description for the purpose of providing relative reference only, and are not intended to suggest any limitations on how any article is to be positioned during use, or to be mounted in an assembly or relative to an environment. Additionally, the term “couple” and variants of it such as “coupled”, “couples”, and “coupling” as used in this description are intended to include indirect and direct connections unless otherwise indicated. For example, if a first device is coupled to a second device, that coupling may be through a direct connection or through an indirect connection via other devices and connections. Similarly, if the first device is communicatively coupled to the second device, communication may be through a direct connection or through an indirect connection via other devices and connections.

It is contemplated that any part of any aspect or embodiment discussed in this specification can be implemented or combined with any part of any other aspect or embodiment discussed in this specification.

The scope of the claims should not be limited by the preferred embodiments set forth in the examples, but should be given the broadest interpretation consistent with the description as a whole.

1. A battery system for an electric motor vehicle comprising:
(a) at least two battery cartridges comprising first and second battery cartridges, wherein the first battery cartridge has a first power connector port with at least one of a shape, size, configuration and orientation that is different than a second power connector port of the second battery cartridge; and
(b) at least two battery compartments comprising first and second battery compartments physically spaced apart and electrically coupled together by a bridging power cable, the bridging power cable comprising first and second connector ends extending respectively into the first and second battery compartments, wherein the first connector end mates with the first power connector port and the second connector end mates with the second power connector port.

2. The battery system of claim 1, wherein the first connector end matches the shape, size, configuration and orientation of the first connector port but does not match at least one of the shape, size, configuration and orientation of the second connector port, and the second connector end matches the shape, size, configuration and orientation of the second connector port but does not match at least one of the shape, size, configuration and orientation of the first connector port.

3. The battery system as claimed in claim 2, wherein the first power connector port has a different orientation on the first battery cartridge than the second power connector port on the second battery cartridge, and the bridging power cable is affixed to the vehicle such that the first and second connector ends have orientations that respectively match the orientations of the first and second power connectors when the first and second battery cartridges are respectively mounted in the first and second battery compartments.

4. The battery system as claimed in claim 3 wherein the first and second power connector ports each have a keyhole shape with a notch section, and wherein the notch section of the first connector port has a different orientation than the notch section of the second connector port.

5. The battery system as claimed in claim 4, wherein the notch sections of the first and second power connector ports face inwardly when the first and second battery cartridges are mounted respectively in the first and second battery compartments.

6. The battery system as claimed in claim 5, wherein the first and second battery compartments are part of a rolling chassis of the electric motor vehicle and are located adjacent to a cockpit of the electric motor vehicle, the first and second battery compartments each further comprising an access port communicative with the cockpit and providing a access for a person's hand to reach one of the respective first and second connector ends and one of the respective first and second connector ports when the first and second battery cartridges are mounted inside the first and second battery compartments.

7. The battery system as claimed in claim 1 wherein at least one of the first and second battery cartridges further comprise a locator pin extending from a front end of the battery cartridge, and a front end of the corresponding battery compartment comprises a locator hole for receiving the locator pin and positioning the battery cartridge such that the power connector port is connectable to the connector end in the battery compartment.

8. The battery system as claimed in claim 7 wherein at least one of the first and second battery cartridges further comprises a mounting bracket extending from a rear end of the battery cartridge, and which aligns with at least one securing bolt when the battery cartridge is positioned with the locator pin in the locator hole, such that the battery cartridge can be secured to the battery compartment only by the at least one securing bolt.

9. The battery system as claimed in claim 1 wherein the first and second battery cartridges each further comprise a plurality of battery modules electrically connected sequentially in series, and wherein a last battery module in the first battery cartridge is electrically coupled to a front power connector port of the first battery cartridge, and wherein a first battery module in the second battery cartridge is electrically coupled to a front power connector port of the second battery cartridge.

10. The battery system as claimed in claim 9 wherein the first and second battery cartridges each further comprise a communications bus comprising an external communications port for communicatively coupling to a battery management system, and multiple pin connectors communicatively coupled to sensors inside the battery compartment.

11. The battery system as claimed in claim 10 wherein the communication bus in each of the first and second battery cartridges are communicatively coupled to at least one voltmeter or at least one thermistor inside the first and second battery cartridges.
